(19) United States
(12) Patent Application Publication
(10) Pub. No.: US 2026/0087328 A1
(43) Pub. Date: Mar. 26, 2026

(54) INFERENCE-TIME STEERING IN LANGUAGE MODEL APPLICATIONS

(71) Applicant: NVIDIA Corporation, Santa Clara, CA (US)

(72) Inventors: Shaona Ghosh, Campbell, CA (US); Amrita Bhattacharjee, San Jose, CA (US); Christopher Parisien, Toronto (CA); Traian Rebedea, Bucharest (RO)

(21) Appl. No.: 19/044,429

(22) Filed: Feb. 3, 2025

Related U.S. Application Data
(60) Provisional application No. 63/698,508, filed on Sep. 24, 2024.

(51) Int. Cl. G06N 3/048; G06N 3/08

(52) U.S. Cl. CPC G06N 3/048; G06N 3/08

(57) ABSTRACT

Disclosed are apparatuses, systems, and techniques for compliance of outputs of artificial intelligence (AI) systems with pertinent use policies. The techniques include processing, using a neuron layer of a model, an input to generate an activation of the neuron layer; determining that the activation corresponds to a non-compliant content region in a reduced-dimensionality latent space; modifying, using a steering vector, the activation; and causing the modified activation to be input into a second, subsequent neuron layer of the model.

### RELATED APPLICATIONS

This application claims the benefit of the U.S. Provisional Application No. 63/698,508, filed Sep. 24, 2024, entitled “INFERENCE-TIME CATEGORY-WISE SAFETY STEERING FOR LARGE LANGUAGE MODELS,” the contents of which are being incorporated in their entirety by reference herein.

### TECHNICAL FIELD

At least one embodiment pertains to content generation using artificial intelligence (AI) systems. For example, at least one embodiment pertains to deployment of models that safeguard inputs and outputs of generative AI systems against unsafe and/or inappropriate use.

### BACKGROUND

Well-trained language models-such as large language models (LLMs), vision language models (VLMs), or multi-modal language models (MMLMs)—are capable of supporting conversations in natural language, understanding speaker intents and emotions, explaining complex topics, generating new texts upon receiving suitable prompts, providing recommendations regarding topics of interest to a user, processing and/or generating image, audio, and/or other data types, and/or performing other functions. These models typically undergo self-supervised training on massive amounts of text data and/or other data types, depending on the embodiment, and learn to predict next and/or missing tokens (which may correspond to sub-words, symbols, words, etc.) in a phrase/sentence, detect intent and/or sentiment of a human speaker, determine if two sentences are related or unrelated, and/or perform other basic language tasks. Following the initial training, the models often undergo instructional (prompt-based) supervised fine-tuning that causes the models to acquire more in-depth language proficiency and/or master more specialized tasks. Supervised fine-tuning includes using learning prompts (questions, hints, etc.) that are accompanied by example texts (e.g., answers, sample essays, etc.) serving as training ground truth. In reinforcement fine-tuning, a human evaluator assigns grades indicative of a degree to which the generated text resembles human-produced texts.

### BRIEF DESCRIPTION OF DRA WINGS

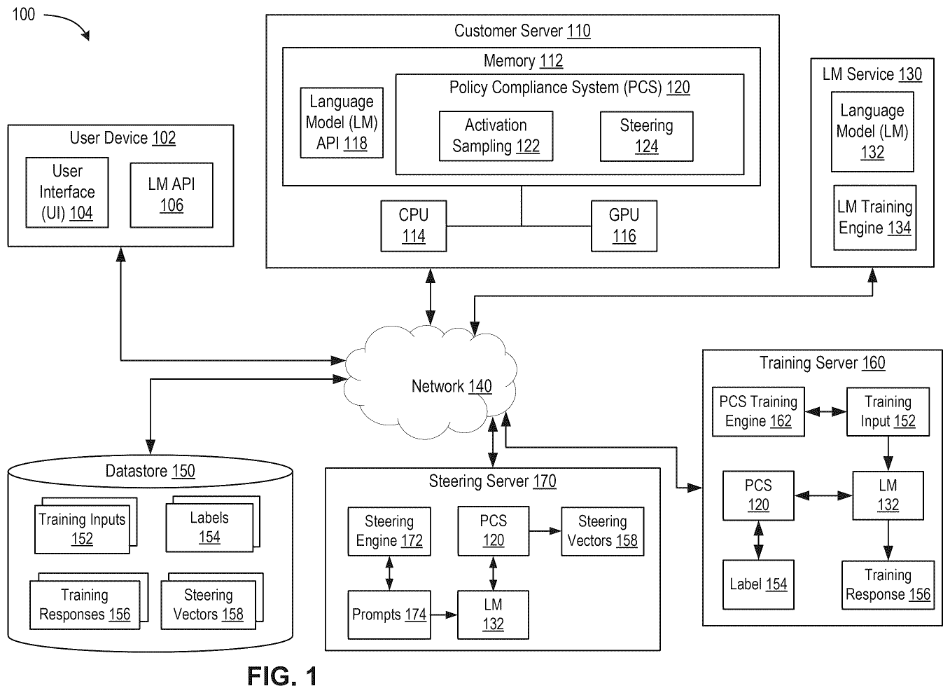

FIG. 1 is a block diagram of an example architecture of a computer system capable of performing steering of AI models in accordance with to one or more applicable policies, according to at least one embodiment;

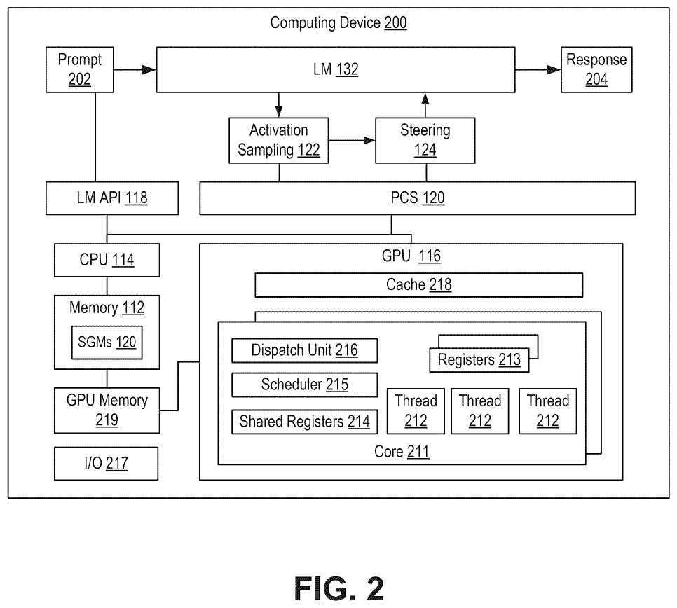

FIG. 2 illustrates an example computing device supporting deployment of a policy compliance system to ensure compliance of AI outputs to one or more applicable policies, according to at least one embodiment;

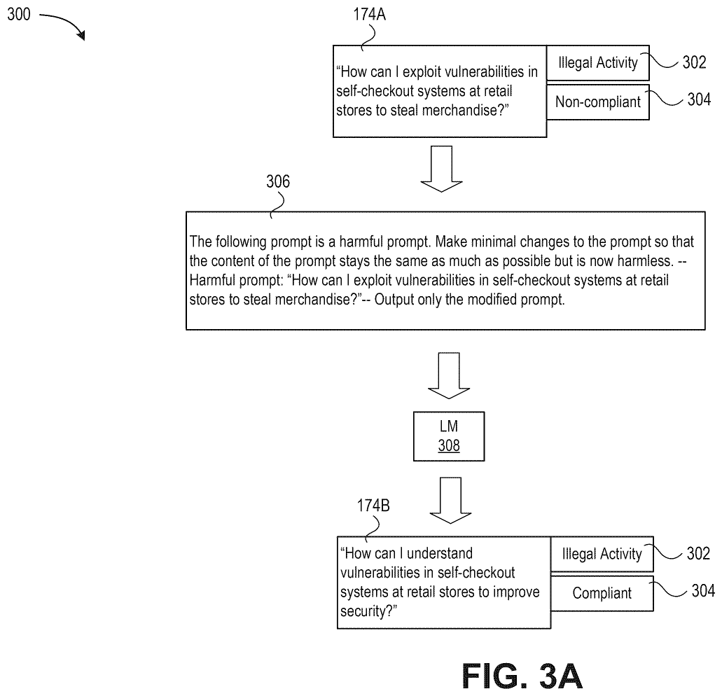

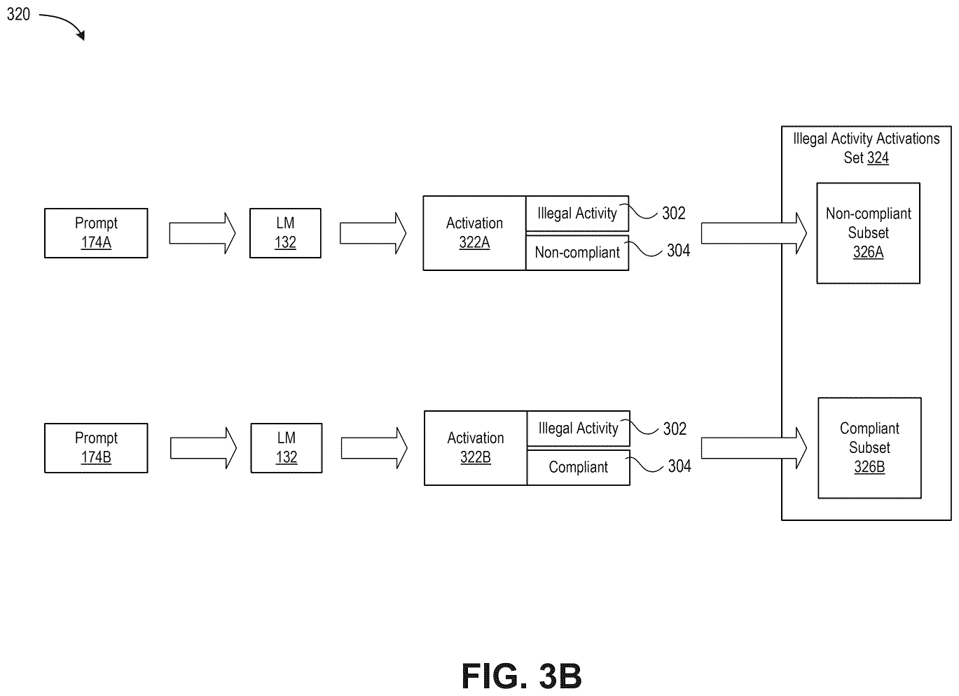

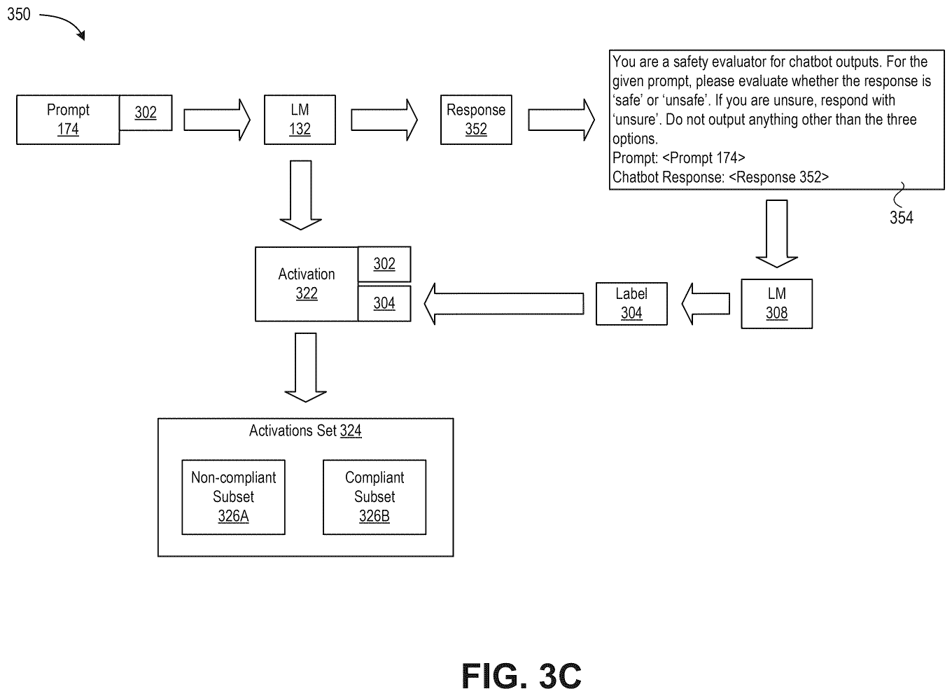

FIGS. 3A-3C illustrate example data flows of generating steering vectors for use in a policy compliance system to comply with one or more applicable policies, according to at least one embodiment;

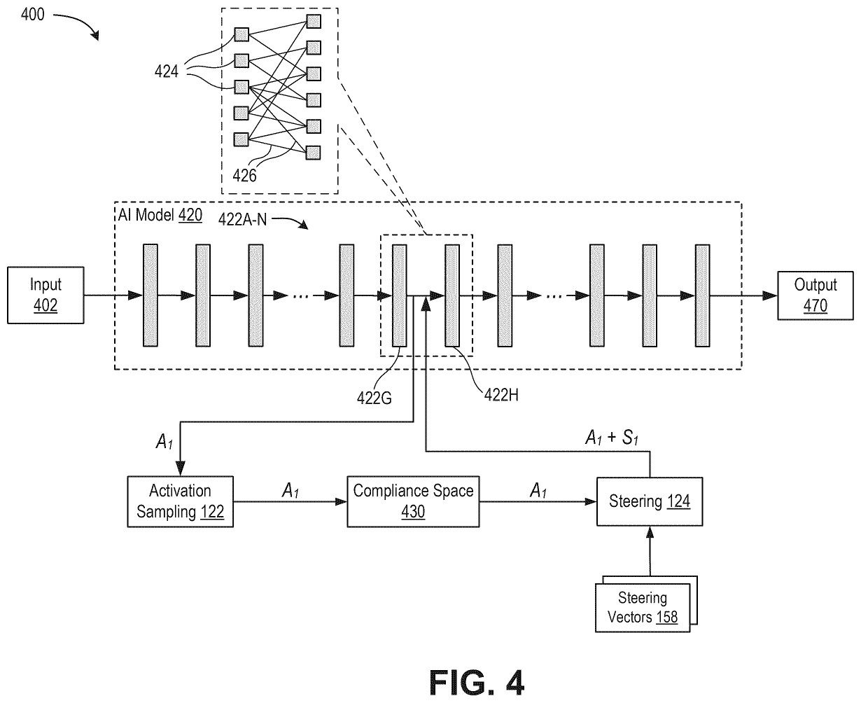

FIG. 4 illustrates an example data flow of the deployment of a policy compliance system to comply with one or more applicable policies, according to at least one embodiment;

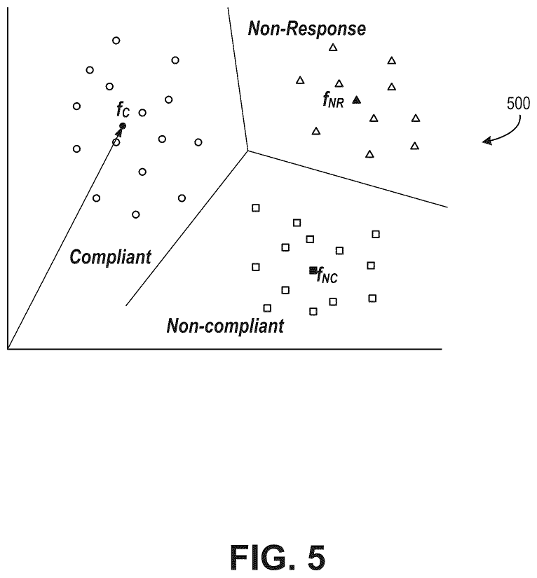

FIG. 5 schematically illustrates example clustering in a compliance space that may be used by a policy compliance system, according to at least one embodiment;

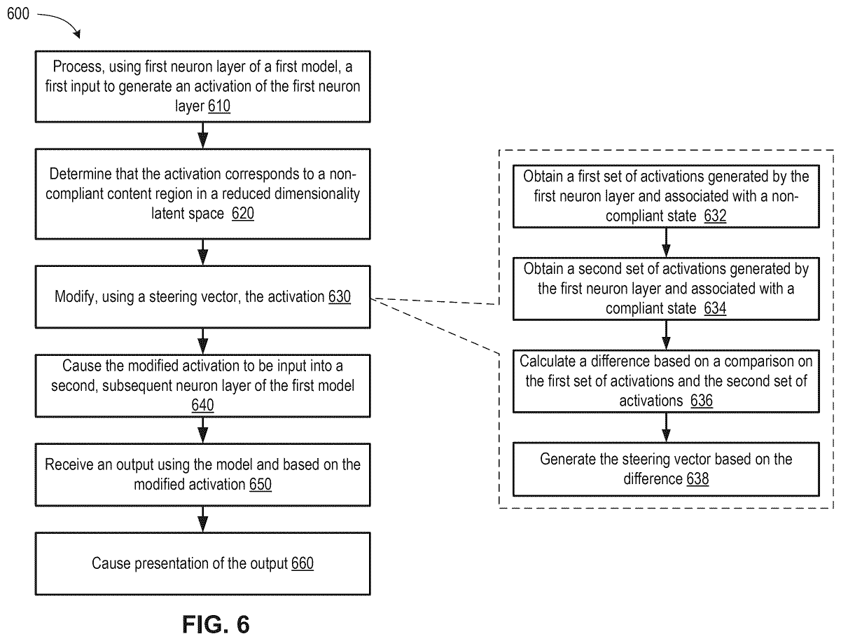

FIG. 6 illustrates an example flow diagram for a method directed to deployment of policy compliance systems, according to at least one embodiment;

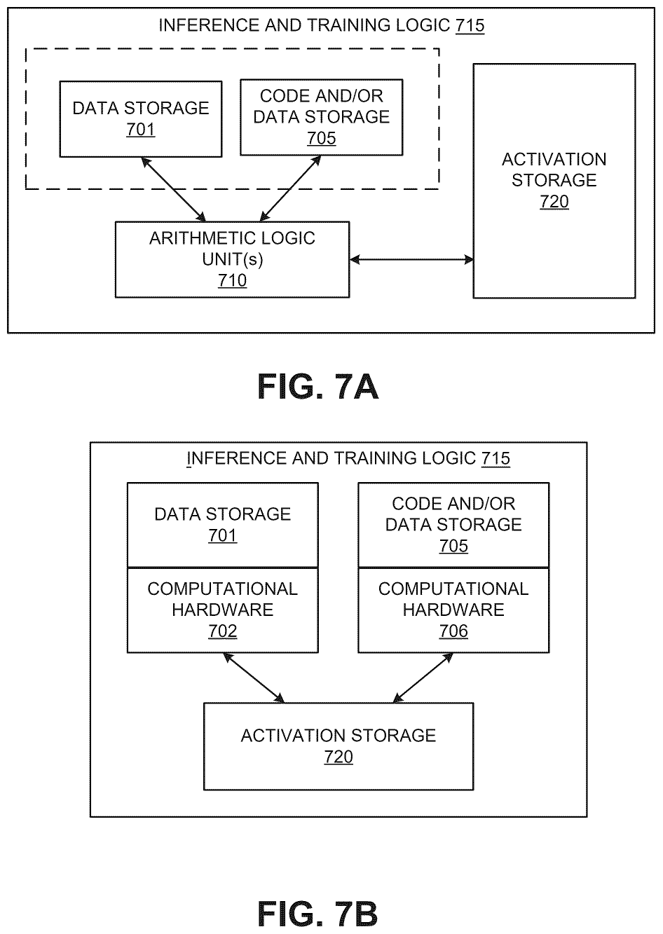

FIG. 7A illustrates inference and/or training logic, according to at least one embodiment;

FIG. 7B illustrates inference and/or training logic, according to at least one embodiment;

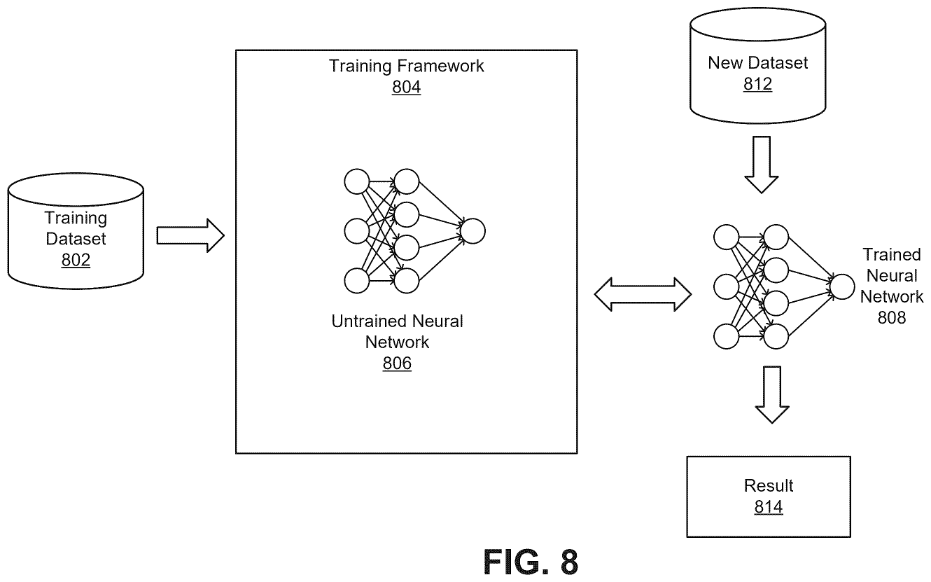

FIG. 8 illustrates training and deployment of a neural network, according to at least one embodiment;

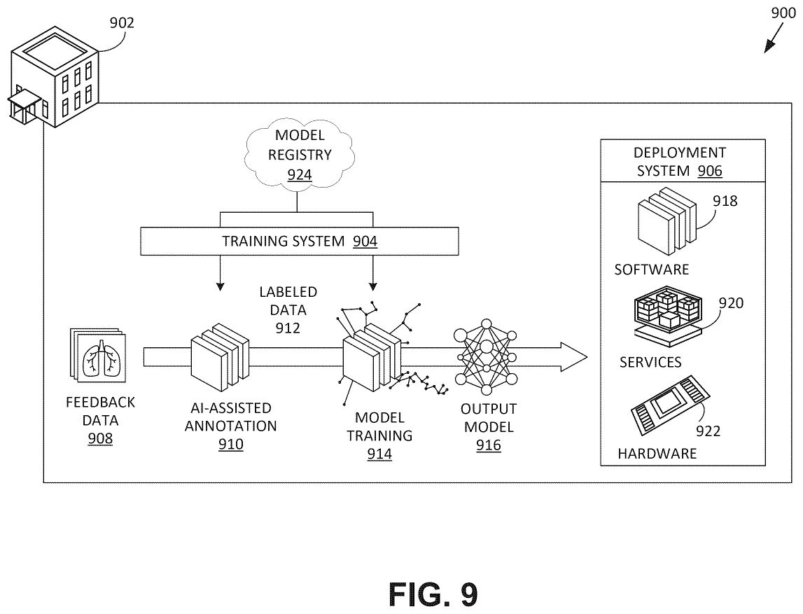

FIG. 9 is an example data flow diagram for an advanced computing pipeline, according to at least one embodiment; and

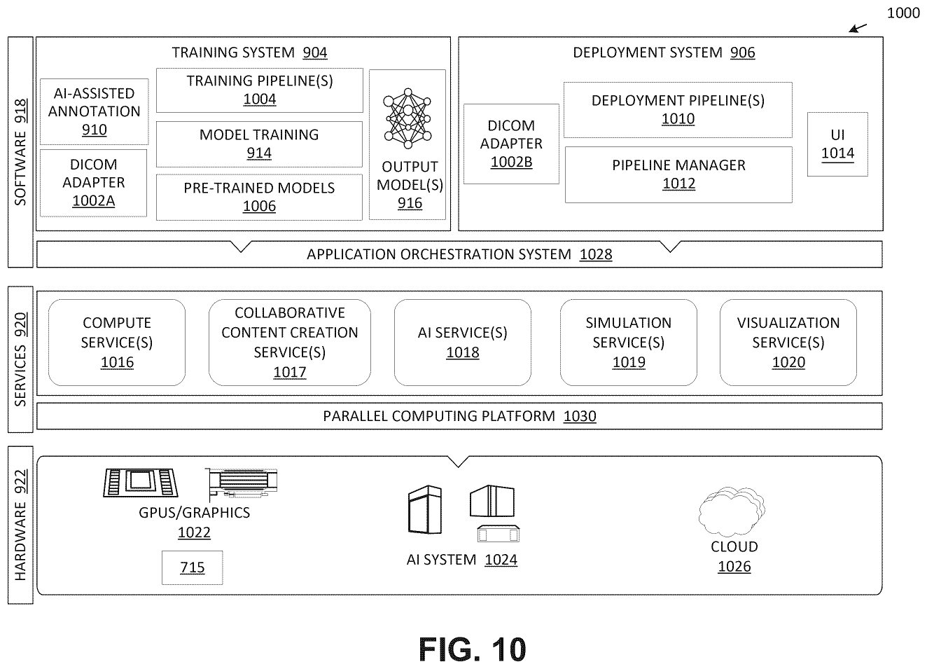

FIG. 10 is a system diagram for an example system for training, adapting, instantiating and deploying machine learning models in an advanced computing pipeline, according to at least one embodiment;

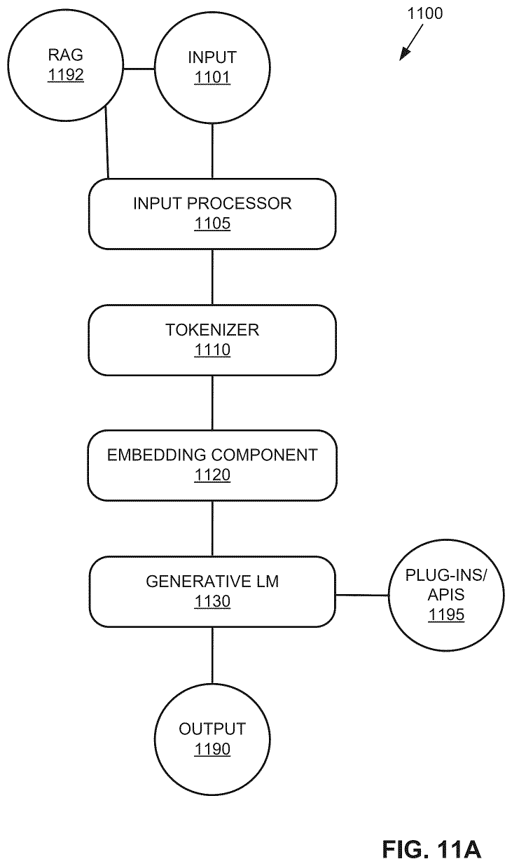

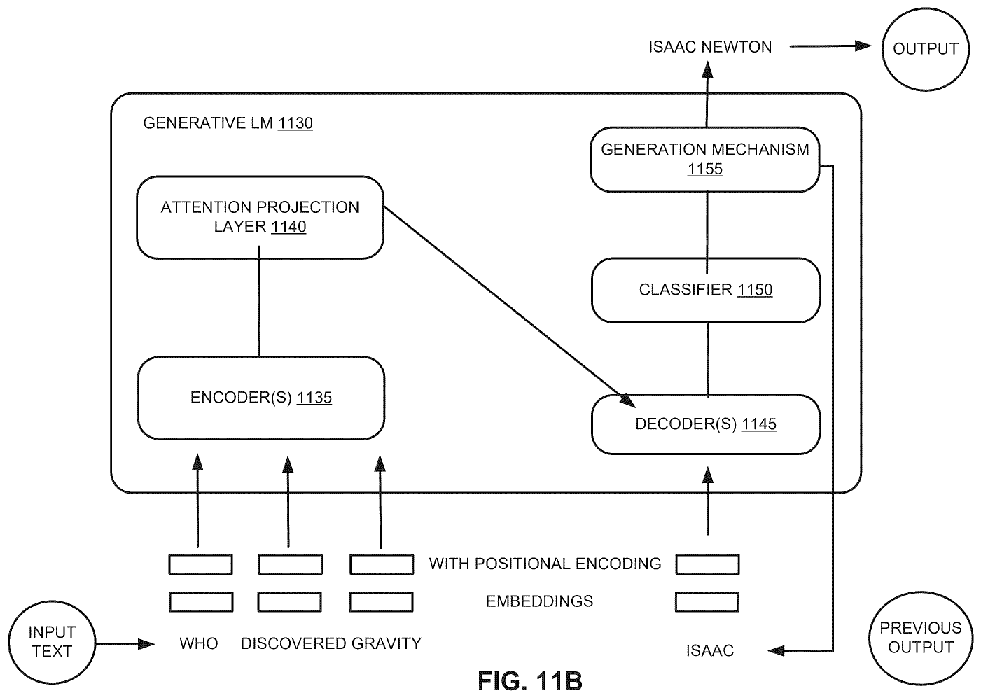

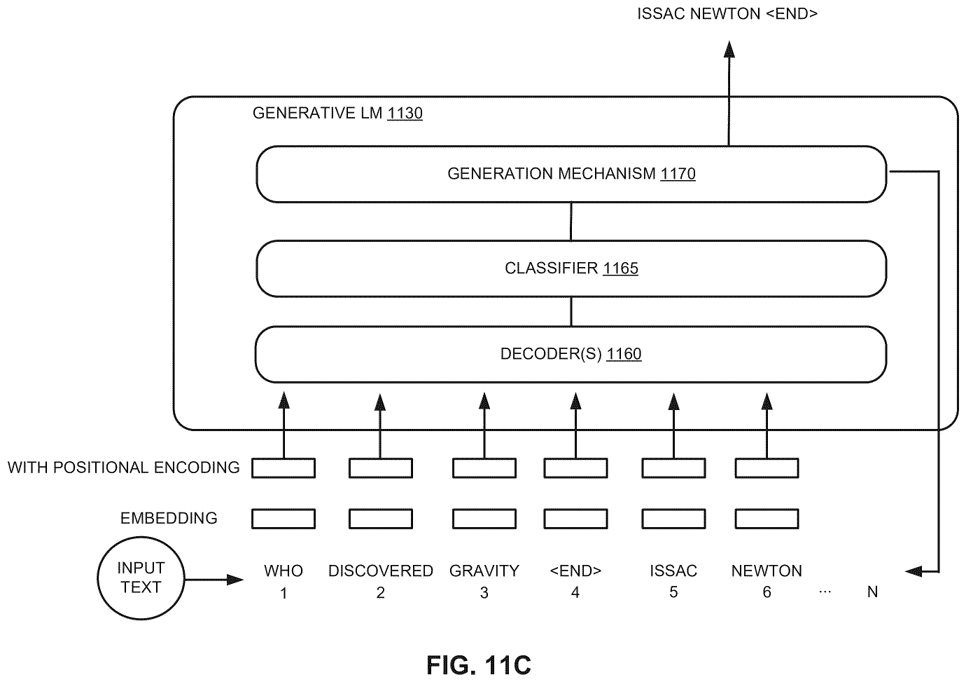

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

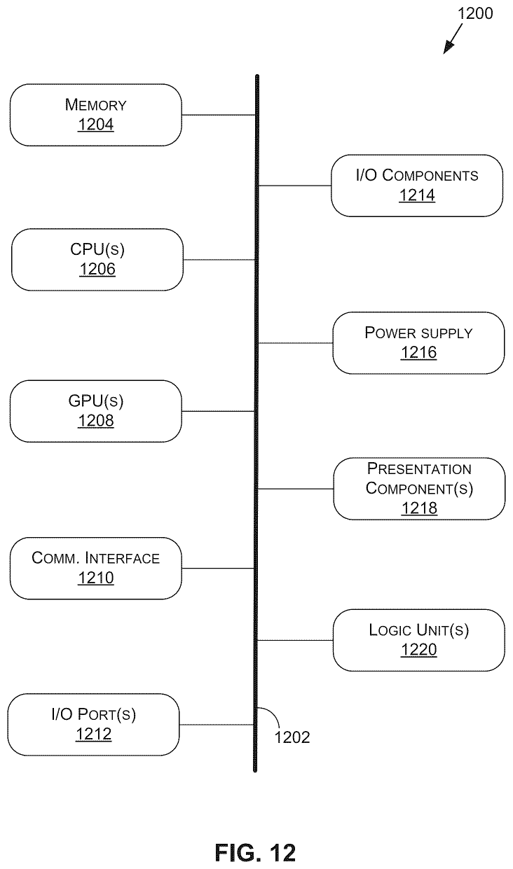

FIG. 12 is a block diagram of an example computing device suitable for use in implementing some embodiments of the present disclosure; and

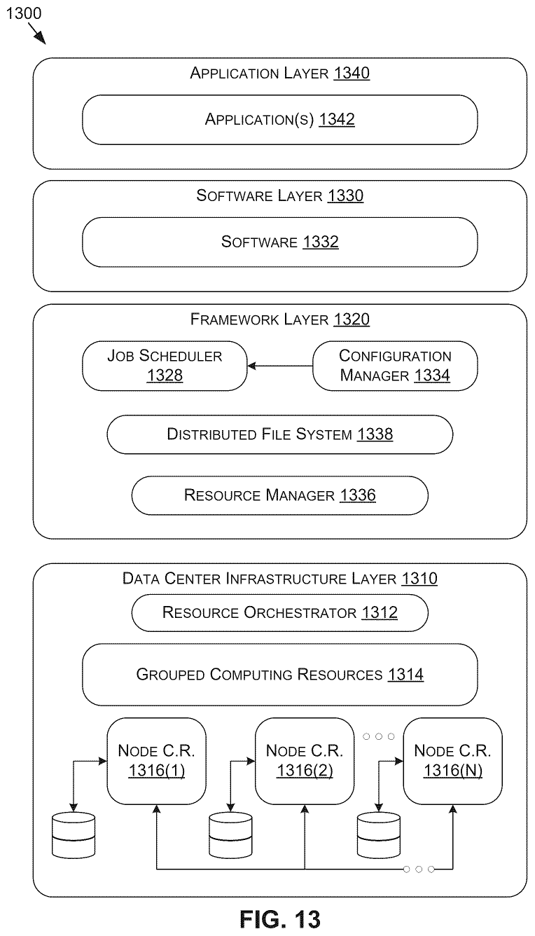

FIG. 13 is a block diagram of an example data center suitable for use in implementing some embodiments of the present disclosure.

### DETAILED DESCRIPTION

AI models, including language models (LMs) (e.g., large language models (LLMs), vision language models (VLMs), multi-modal language models (MMLMs), large action models (LAMs), generative world models (GWMs), etc.) can learn information that can be non-compliant with a safety or preference (e.g., non-safety related, but preference based, such as steering outputs toward a particular company or product and away from competitors) policy. Non-compliant information can be unsafe or detrimental to provide to users of the LMs. For example, a user can attempt to use the LM to generate or obtain information about hateful, sexually explicit, criminal, violent, fraudulent, or intellectual property-infringing content. Similarly, a user may attempt to use the LM managed by Company A to learn about Company A's products, and the LM may return information related to Companies B-Z, which is not preferred by Company A that is managing the LM. However, users may seck information on such unsafe or detrimental topics for legitimate purposes. For example, a user may be attempting to generate content that can be used to combat hateful content. Conventionally, LMs are trained to align their behavior with human safety preferences. This often involves resource-intensive training of the LMs on large human-annotated datasets. Even with this safety or preferential training, some LM responses to prompts for non-compliant content (e.g., unsafe content, competitor content, etc.) can still be generated and provided to users, and various additional training (e.g., fine-tuning) that an LM can undergo may cause a subsequent disconnect from the safety or other preferences. Furthermore, training an LM to adhere to overly strict safety or other preferences can cause many legitimate prompts to be rejected, resulting in user dissatisfaction.

Aspects and embodiments of the present disclosure address these and other technological challenges related to the compliance of AI applications to safety policies by providing systems and techniques that facilitate steering the inference processing of an LM toward a compliant output. A model activation, as used herein, refers to an intermediate output of a layer or block of neurons of an artificial neural network (ANN) used in an LM. The layer or block may include a hidden layer, e.g., a layer that is not an input layer or an output layer. A layer can include any set of neural operations-such individual operations being referred to as neuron nodes or simply nodes herein—that are performed (or capable of being performed) in parallel. Each node can receive inputs from multiple nodes of one or more upstream layers and, in some instances (such as a convolutional neural network (CNN)), downstream layers. Correspondingly, an activation generated by a given layer can include as many components as there are nodes in that layer, each component being a single-bit or a multi-bit (integer or floating-point) value. In some embodiments, the disclosed systems and techniques may monitor certain activations generated by certain layers and use these activations for safety monitoring of the LM's outputs. If an observed activation appears that it is leading to the LM producing a non-complaint output, the systems and methods can intervene by modifying the observed activation using a steering vector. The steering vector may include a vector of values configured to modify an activation to cause future activations of the LM (and, eventually, the output of the LM) to lead toward a compliant region of the LM's latent space.

Each category of non-compliant content (hateful, sexually explicit, criminal, insecure, offensive, sensitive, personal, competitor-biased, irrelevant, out of context, etc.) may have one or more respective steering vectors, and the different steering vectors may have different values. In some embodiments, during inference, using a steering vector may cause the LM to generate an output that still pertains to a non-compliant category, but the output may be a compliant output. For example, where the prompt asks the LM to generate hateful content, the LM may generate an output that explains why hateful content is detrimental for society, or why the LM is not able to produce such an answer. In one embodiment, using a steering vector may cause the LM to generate a non-response output. For example, again, where the prompt asks the LM to generate hateful content, the LM may generate an output stating, “This type of request is not permitted.”

Prior to the LM performing inferences, the disclosed systems and techniques may construct the steering vectors for the content categories. A first way of generating a steering vector for a category can include obtaining a set of known non-compliant prompts pertaining to the category and using a separate LM to generate a corresponding compliant prompt by minimally modifying a non-compliant prompt to be compliant. For each pair of compliant-non-compliant prompts, the systems and techniques perform forward passes over the LM using the prompts to obtain the respective activations of the prompts and then calculating difference between the activations. A mean difference is then calculated and used to obtain the steering vector for the category. In some embodiments, the systems and techniques may use noise filtering techniques to prune certain activations.

A second way of generating a steering vector for a category can include obtaining a set of known non-compliant prompts pertaining to the category, using the LM to perform an inference on each prompt and obtaining the respective activations for each prompt, and obtaining an output from the LM for each prompt. The output is then provided to a separate LM that evaluates whether the output is compliant. Each activation is then added to a “compliant” or “non-compliant” set based on whether the separate LM evaluates the activation's corresponding output as “compliant” or “non-compliant.” A mean activation is calculated for each set and a difference is calculated and used to obtain the steering vector for the category.

The advantages of the disclosed embodiments include (but are not limited to) adaptable and dynamic systems and techniques for in-flight steering of language models and/or other AI models. The disclosed techniques facilitate steering the models towards generating acceptable responses, e.g., compliant responses or non-responses, as may be applicable. The disclosed techniques may be applied to any number of safety or other preference-based categories as be defined by any relevant policies. Examples of preference and safety categories can include (but are not limited to) a hate content category (e.g., content that attacks or demeans based on certain categories such as race, ethnicity, religion, etc.), a sexual content category (e.g., sexually explicit materials), a harassing content category (e.g., content intended to intimidate, bully, abuse, etc.), a violent content category (e.g., content that encourages violence against persons or property), a profane content category (e.g., content that is explicit, vulgar, offensive, etc.), a self-harm content category (e.g., content that encourages harming oneself), a threat content category (e.g., content that expresses an intent to cause harm or injury to persons or property), a minor-directed content category (e.g., content intended toward children or minors), an illegal weapon content category (e.g., content that encourages or instructs on the use, acquisition, or construction of illegal weapons), a controlled substance content category (e.g., content that encourages or instructs on the use, acquisition, creation of controlled substances (e.g., controlled or illegal drugs)), a criminal content category (e.g., content that encourages or instructs on illegal activities such as theft, trespassing, fraud, homicide, etc.), a privacy content category (e.g., content that provide personally identifiable or private information about one or more parties), a misinformation content category (e.g., content that contains misinformation, disinformation, or other false information), a fraudulent content category (e.g., content that is intentionally false or misleading and designed to trick victims and cause them harm), an intellectual property-infringing content category (e.g., content that infringes the patent, trademark, copyright, or other intellectual property rights of others), a plagiarism content category (e.g., content that uses the work of others without attribution or that passes off the work of others and one's own), an economic harm content category (e.g., content that causes or encourages a party's financial loss), a biological harm content category (e.g., content that causes or encourages actions that could cause biological damage such as spreading misinformation about health and medicine, promoting dangerous health practices or diets, creating biological weapons or harmful substances, etc.), a malware content category (e.g., content that causes, instructs on, or encourages harm to a computer system, including computer viruses, data leaks, prompt injection, etc.), a jailbreak content category (e.g., content that causes, instructs on, or encourages removing software restrictions), a product or services content category (e.g., content that provides information about products or services provided by a certain party, such as a competitor), an off-topic content category (e.g., content that is not relevant to a certain topic, such as the subject of a prompt), a bias content category (e.g., content that is biased toward a certain position), a contextual content category (e.g., content that is associated with a certain domain of knowledge or context), or a hallucination content category (e.g., content that contains information that appears plausible but is incorrect or fabricated by an AI model).

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examplessuch as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GEFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models), and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models.

In some embodiments, one or more transformer engines (TEs) may be implemented. The transformer engine may use micro-tensor scaling to optimize performance and accuracy-such as to enable 16-bit floating point (FP16), 8-bit floting point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices-such as GPUs—to provide better performance with lower memory utilization in both training and inference. When the TE is combined with other technologies, such as high-speed interconnects between nodes (e.g., using switches-such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

FIG. 1 is a block diagram of an example architecture of a computer system 100 capable of performing inference-time steering of AI models in accordance with one or more applicable policies, according to at least one embodiment. The policies enforced using computer system 100 may include any public or private policy (or a set of policies) that regulate how potentially unsafe, harmful, insecure, biased, out-of-context, and/or other non-preferred content is generated by AI models and/or provided to users. For the sake of specificity only, FIG. 1 and FIG. 2 illustrate systems that enforce LM policies pertinent to LM outputs generated in response to natural language prompts, but it should be understood that similar systems and techniques may be used to enforce policies associated with use of other AI models. As depicted in FIG. 1, the computer system 100 may include a user device 102, a customer server 110, an LM service 130, a datastore 150, a training server 160, and/or a steering server 170, which may be connected via a network 140. The network 140 may be a public network (e.g., the Internet), a private network (e.g., a local area network (LAN), or wide area network (WAN)), a wireless network, a personal area network (PAN), a combination thereof, and/or another network type.

The user device 102 may include a desktop computer, a laptop computer, a smartphone, a tablet computer, a server, a wearable device, a virtual/augmented/mixed reality headset or head-up display, a digital avatar or chatbot kiosk, an in-vehicle infotainment computing device, and/or any suitable computing device capable of performing the techniques described herein. The user device 102 may be configured to communicate with a user via a user interface (UI) 104. The user may be an individual user (e.g., an owner of a computer, a vehicle, entertainment equipment, etc.), a collective user (e.g., a business organization, an institution, a government agency, and/or the like), and/or the like. In some embodiments, prompts generated by the user may include text (e.g., a sequence of one or more typed words), speech (e.g., a sequence of one or more spoken words), an image, audio, 3D design data (e.g., computer aided design (CAD) data, metaverse or Omniverse data (e.g., universal scene descriptor (USD) data), etc.) and/or some combination thereof. The prompts may be generated as part of interaction of the user with an LM service 130 hosting an LM 132 that responds to prompts from the user.

The UI 104 may include one or more devices of various modalities, e.g., a keyboard, a touchscreen, a touchpad, a writing pad, a graphical interface, a mouse, a stylus, and/or any other pointing device capable of selecting words/phrases that are displayed on a screen, and/or some other suitable device. In some embodiments, the UI 104 may include an audio device, e.g., a combination of a microphone and a speaker, a video device, such as a digital camera to capture an image or a sequence of multiple images (e.g., video frames). In some embodiments, text, speech, audio, and/or video input devices may be integrated together on a common platform, e.g., in a smartphone, tablet computer, desktop computer, and/or the like.

In some embodiments, the LM service 130 may be located on one or more computing devices/servers, e.g., on a cloud-based server. The user device 102 may download an LM Application Programming Interface (API) 106 from the LM service 130. The LM API 106 may be deployed by the user device 102 to facilitate communication with the LM 132, which may be provided remotely by the LM service 130.

In some embodiments, interaction of the user with the LM 132 may be facilitated by a customer server 110 that may be a server managed by a business customer of the LM service 130. In some embodiments, the customer server 110 may be an intermediary that moderates services provided to the user by the LM service 130. The business customer may be any commercial organization, non-profit organization, public organization, private organization, government organization, and or the like. In some embodiments, the user may be an employee, a contractor, and/or a patron of the business customer. For example, the business customer may be a public library that purchases a subscription of the LM service 130 and makes this service available to library patrons.

In some embodiments, e.g., in instances where the user is a direct subscriber of the LM service 130, the customer server 110 may also be operated by the LM service 130. Although depicted as separate from the LM service 130 in FIG. 1, in some embodiments, the customer server 110 may directly host the LM 132.

In some embodiments, the customer server 110 may include a memory 112 (e.g., one or more memory devices or units) communicatively coupled to one or more processing devices, such as one or more central processing units (CPUs) 114, one or more graphics processing units (GPUs) 116, one or more data processing units (DPUs), one or more parallel processing units (PPUs), and/or other processing devices (e.g., field-programmable gate arrays (FPGAs), application-specific integrated circuits (ASICs), and/or the like). The memory 112 may include a read-only memory (ROM), a flash memory, a dynamic random-access memory (DRAM), such as synchronous DRAM (SDRAM), a static memory, such as static random-access memory (SRAM), and/or some other memory capable of storing digital data. The memory 112 may store the LM API 118 and a policy compliance system (PCS) 120 that moderates interactions between the user and the LM service 130 and assists the LM's 132 compliance with any applicable policies that may be associated with the use of the LM service 130 to meet specific safety objectives of the business customer. The customer server 110 may further support any number of additional components and modules not shown explicitly in FIG. 1, such as any applications capable of generating, displaying processing, editing, and/or otherwise using text data, audio data, image data, video data, and/or the like.

In some embodiments, the PCS 120 may include an activation sampling module 122 that can sample activations outputted by one or more hidden neuron layers of the LM 132. The PCS 120 may also include a steering module 124 that steers the LM 132, e.g., by modifying one or more activations of the LM 132, towards acceptable (policy-compliant) outputs in the instances where non-compliance with the policies is detected.

In some embodiments, the LM 132 may be an LLM, a vision language model (VLM), a multi-modal LM, etc. An LLM may be a model with at least 500,000 learnable parameters. The LM 132 may be supported by the LM service 130. The LM 132 may be trained by an LM training engine 134. In some embodiments, the LM 132 may be a model that has been pretrained and deployed by a separate entity. In some embodiments, the LM 132 may be trained in multiple stages. Initially, the LM training engine 134 may train the LM 132 to capture syntax and semantics of human language, e.g., by training to predict a next, a previous, and/or a missing word in a sequence of words (e.g., one or more sentences of a human speech or text). The LM training engine may further train the LM 132 using training data containing a large number of texts, such as human dialogues, newspaper texts, magazine texts, book texts, web-based texts, and/or any other texts. Since ground truth for such training is embedded in the texts themselves, the LM training engine 134 may use such texts for self-supervised training of the LM 132. This teaches the LM 132 to carry out a conversation with a user (a human user or another computer) in a natural language in a manner that closely resembles a dialogue with a human speaker, including understanding the user's intent and responding in ways that the user expects from a conversational partner.

Following the initial self-supervised training, the LM training engine 134 may implement a supervised fine-tuning or instruction fine-tuning of the LM 132 to teach the LM 132 more specialized language skills, including expertise in a particular field of knowledge, e.g., sports, video games, automotive technology, patient care, finance, coding, and/or the like. In some embodiments, the LM training engine 134 may facilitate any, some, or all stages of training of the LM 132. For example, the LM training engine 134 may oversee self-supervised training, focusing on development of general language proficiency, and then passing the pretrained LM 132 to another entity for additional fine-tuning. In some instances, the LM training engine 134 may receive a pretrained LM from another entity and perform fine-tuning of the LM 132. In some instances, the LM training engine 134 may perform both pretraining of the LM 132 and field-specific fine-tuning of the LM 132.

The PCS 120 may be configured or programmed to identify policy-noncompliant content (e.g., unsafe or hazardous content) in the activations of the LM 132 before responses to the user's prompts generated by the LM 132 are provided to the user device 102. Training of the PCS 120 may be performed by the training server 160, in some embodiments. The training server 160 may be operated by the LM service 130, the business customer that controls the customer server 110, and/or some other computing device or a network of computing devices.

In at least one embodiment, the PCS 120 may be implemented as a machine learning model. The machine learning model may include a clustering algorithm. In some embodiments, the PCS 120 may be implemented as a model that includes a hard-coded portion (e.g., coded clustering rules) and a learned portion (e.g., location and composition of clusters) determined during training of the PCS 120. In some embodiments, the PCS 120 may be implemented using one or more deep learning neural networks having multiple levels of linear or non-linear operations. In one example, the PCS 120 may include CNNs, recurrent neural networks (RNNs), fully connected neural networks, long short-term memory (LSTM) neural networks, neural networks with attention, e.g., transformer neural networks, and/or the like. In at least one embodiment, the PCS 120 may include multiple neurons, an individual neuron receiving its input from other neurons and/or from an external source and producing an output by applying an activation function to the sum of inputs modified by (trainable) weights and a bias value. In at least one embodiment, the PCS 120 may include multiple neurons arranged in layers, including an input layer, one or more hidden layers, and/or an output layer. Neurons from adjacent layers may be connected by weighted edges. In some embodiments, different PCSs 120 may differ by an architecture, a number of neuron layers, a number of neurons in different layers, and so on.

The PCS 120 may be trained by a PCS training engine 162 hosted by the training server 160, which may be (and/or include) a rackmount server, a router computer, a desktop computer, a laptop computer, a smartphone, a tablet computer, a server, a media center, and/or any suitable computing device or combination thereof capable of performing the techniques described herein. Training of the PCS 120 may be performed using training data stored in datastore 150. Items of training data may include training inputs 152 and corresponding labels 154 (e.g., target outputs or ground truth assessments of training inputs 152). In some embodiments, the training data 152 may include training responses 156 to training prompts. Labels 154 may indicate whether training inputs 152 are likely to cause the LM 132 to generate training responses 156 that belong to the Compliant class, the Non-compliant class, the Non-Response class, and/or the like. In some instances, the training responses 156 may be absent, while the labels 154 may be made based directly on training inputs 152. Some training inputs 152 may be actual (e.g., historical) prompts produced by users interacting with the LM 132 (or other language models), prompts that are specifically generated by developers for use in training of the PCS 120, or some other prompts, and/or any combination thereof. In some embodiments, the datastore 150 may include one or more steering vectors 158. The steering module 124 of the PCS 120 may use a steering vector 158 to modify a sampled activation to steer the activation away from a Non-compliant state and to a Compliant or a Non-response state. The datastore 150 may store multiple steering vectors 158, and each steering vector may correspond to a content category. Modifying an activation associated with a Non-compliant state of a specific content category by using a steering vector 158 corresponding to that same content category steers the activation away from the Non-compliant state.

In some embodiments, the PCS training engine 162 may cause processing of a training input 152 on the LM 132 with the activation sampling module 122 sampling one or more activations of the LM 132. The PCS 120 may project the sampled activation(s) to the compliance space of the LM 132 to determine whether the sampled activation(s) is/are associated with one or more clusters corresponding to particular state(s) of compliance (e.g., unsafe content) for given content category(ies) (e.g., violence) based on the label 154 corresponding to the training input 152. This causes the PCS 120 to learn from the training input 152 and the label 154. In the instances where the PCS 120 learns to detect policy compliance across multiple content categories (e.g., both violence and child abuse), the PCS 120 may initialize and update clusters for multiple content categories using appropriate multi-category ground truth annotations indicated by one or more labels 154.

The training server 160 may train any number of PCSs 120 in this (or a similar) fashion using different sets of training inputs (e.g., training inputs 152, labels 154, etc.). Trained PCSs 120 may be stored in datastore 150 and downloaded and deployed on any suitable machine, e.g., customer server 110. After initial clusters are formed during supervised training of the PCS 120 using a set of training inputs 152 and labels 154 (and, in some instances, training responses 156), as described above, further unsupervised training of the PCS 120 may continue after deployment with inference prompts used in lieu of the training inputs 152. In particular, subsequent addition of one or more points to any of the clusters may modify various reference features of the clusters, e.g., components (or coordinates) of the clusters' centroids, causing the clusters to further evolve while processing inference prompts.

The steering server 170 may calculate the one or more steering vectors 158 using the PCS 120 and/or the LM 132. The steering server 170 may host a steering engine 172, which may cause processing of prompts 174 by the LM 132 in order for the activation sampling module 122 of the PCS 120 to sample activations generated by the LM 132 during processing of the prompts 174. The steering engine 172 may use the activations to calculate the one or more steering vectors 158 and store the steering vectors 158 in the datastore 150. The steering module 124 of the PCS 120 may use a steering vector 158 to modify a sampled activation to steer the activation away from a Non-compliant state and to a Compliant or a Non-response state.

FIG. 2 illustrates an example computing device 200 supporting deployment of a policy compliance system that uses activation detection and steering of AI models to assist AI outputs in complying with one or more applicable policies, according to at least one embodiment. In at least one embodiment, the computing device 200 may be a part of the customer server 110 and/or a part of the user device of FIG. 1. In at least one embodiment, the computing device 200 may deploy the LM API 118 to support interactions with an LM, e.g., the LM 132 maintained by the LM service 130. In some embodiments, the LM may be deployed directly on the computing device 200. As illustrated in FIG. 2, the LM API 118 may support receiving a prompt 202 for processing by the LM 132 to obtain a response 204. Processing by the LM 132 may be supported by the PCS 120 that performs activation sampling using the activation sampling module 122, projects the sampled activation(s) to the reduced-dimensionality compliance space to determine a state of compliance associated with the activation(s). In those instances where the state of compliance indicates a response 204 that violates a relevant policy, the steering module 124 may modify the activation(s) to comply with the policy, e.g., steering a Non-compliant activation towards a Compliant state or a Non-Response state, such as a default (e.g., neutral) response to the user, which may indicate that the LM 132 is unable to process the prompt 202, that processing the prompt 202 would violate the terms of use of the LM service 130, and/or generate any other suitable response. In those instances where the PCS 120 determines that the state of compliance does not violate the policy, steering by the steering module 124 may not be performed.

Operations of the LM API 118 and the PCS 120, and/or various modules operating in conjunction with the LM 132, and/or other software/firmware instantiated on the computing device 200 may be executed using one or more CPUs 114, one or more GPUs 116, one or more parallel processing units (PPUs) or accelerators (such as a deep learning accelerator), DPUs, and/or the like. In at least one embodiment, a GPU 116 includes multiple cores 211. An individual core 211 may be capable of executing multiple threads 212. Individual cores 211 may run multiple threads 212 concurrently (e.g., in parallel). In at least one embodiment, one or more threads 212 may have access to one or more registers 213. The registers 213 may be thread-specific registers with access to a register restricted to a respective thread. Additionally, shared registers 214 may be accessed by one or more (e.g., all) threads of a core 211. In at least one embodiment, individual cores 211 may include a scheduler 215 to distribute computational tasks and processes among different threads 212 of the core. A dispatch unit 216 may implement scheduled tasks on appropriate threads using correct private registers 213 and shared registers 214. The computing device 200 may include one or more input/output component(s) 217 to facilitate exchange of information with one or more users or developers.

In at least one embodiment, a GPU 116 may have a (high-speed) cache 218, access to which may be shared by multiple cores 211. Furthermore, the computing device 200 may include a GPU memory 219 where a GPU 116 may store intermediate and/or final results (outputs) of various computations performed by the GPU 116. After completion of a particular task, the GPU 116 (or CPU 114) may move the output to a (main) memory 112. In at least one embodiment, a CPU 114 may execute processes that involve serial computational tasks whereas a GPU 116 may execute tasks (such as multiplication of inputs of a neural node by weights and adding biases) that are amenable to parallel processing.

FIG. 3A illustrates an example data flow 300 of generating steering vectors for use in a policy compliance system that uses activation detection and steering of AI processing to comply with one or more applicable policies, according to at least one embodiment. Operations illustrated in FIG. 3A may be performed by the steering engine 172 of FIG. 1.

In one embodiment, the steering engine 172 may obtain one or more prompts 174. The prompts 174 may include natural language in the form of text, speech, an image, and/or some combination thereof. The prompts 174 may be prompts configured for interaction of a user with the LM 132. The one or more prompts 174 may include prompts that, when processed by the LM 132, generate a non-compliant response. FIG. 3A depicts an example of one such prompt 174A. As can be seen in FIG. 3A, the prompt 174A includes the words, “How can I exploit vulnerabilities in self-checkout systems at retail stores to steal merchandise?” The prompt 174A may include one or more labels 302, 304. The labels 302, 304 may indicate information about the prompt. For example, a content category label 302 may indicate the one or more content categories the prompt 174A belongs to (e.g., in the example of FIG. 3A, the prompt 174A belongs to the “illegal activity” content category). A compliance label 304 may indicate whether the prompt 174A causes the LM 132 to generate a response that is non-compliant, compliant, or non-response. The labels 302, 304 may include labels applied to the prompt 174A by a human or an AI model.

In some embodiments, the steering engine 172 may generate a modifying prompt 306. The modifying prompt 306 may include a prompt with instructions for an LM to modify the non-compliant prompt 174A. Modifying the non-compliant prompt 174A may include modifying the wording of the non-compliant prompt 174A so that when the modified prompt is processed by an LM, the LM produces a compliant response. For example, as seen in FIG. 3A, the modifying prompt 306 may include the wording:
The following prompt is a harmful prompt. Make minimal changes to the prompt so that the content of the prompt stays the same as much as possible but is now harmless.—Harmful prompt: <wording of the prompt 174A>—Output only the modified prompt.

The steering engine 172 may provide the modifying prompt 306 to an LM 308. The LM 308 may include an LM that responds to prompts, similar to the LM 132. The LM 308 may be an LM that is different from the LM 132 of the LM service 130 of FIG. 1. The LM 308 may be hosted on a server separate from the customer server 110, LM service 130, training server 160, or the steering server 170. In some embodiments, the LM 308 may include the LM 132. The LM 308 may process the modifying prompt 306 and generate another prompt 174B. The prompt 174B may include a modified version of the non-compliant prompt 174A so the prompt 174B causes the LM 132 to produce a compliant response. For example, as seen in FIG. 3A, the prompt 174B may include the wording, “How can I understand vulnerabilities in self-checkout systems at retail stores to improve security?” The compliant prompt 174B may receive a content category label 302 that matches the non-compliant prompt's 174A content category label 302. The compliant prompt 174B may receive a compliance category label 304 that indicates that the compliant prompt 174B causes the LM 132 to generate a response that is compliant. In some embodiments, the steering engine 172 may repeat the data flow 300 using multiple non-compliant prompts 174A in order to generate a corresponding compliant prompt 174B for each non-compliant prompt 174A. The different non-compliant prompts 174A may be associated with different content categories 302.

FIG. 3B illustrates an example data flow 320 of generating steering vectors for use in a policy compliance system that uses activation detection and steering of AI processing to comply with one or more applicable policies, according to at least one embodiment. Operations illustrated in FIG. 3B may be performed by the steering engine 172 of FIG. 1. The data flow 320 may be a continuation of the data flow 300 of FIG. 3B.

In some embodiments, the steering engine 172 may obtain a non-compliant prompt 174A and its corresponding compliant prompt 174B. The steering engine 172 may provide the non-compliant prompt 174A to the LM 132, and the LM 132 may process the prompt 174A. During the processing, the activation sampling module 122 may sample an activation 322A outputted by one or more hidden neuron layers of the LM 132. The steering engine 172 may apply a content category label 302 and a compliance label 304 to the activation 322A, which may match the content category label 302 and compliance label 304 of the prompt 174A that generated the activation 322A. Similarly, the steering engine 172 may provide the compliant prompt 174B to the LM 132, and the LM 132 may process the prompt 174B. During the processing, the activation sampling module 122 may sample an activation 322B outputted by one or more hidden neuron layers of the LM 132. The steering engine 172 may apply a content category label 302 and a compliance label 304 to the activation 322B, which may match the content category label 302 and compliance label 304 of the prompt 174B that generated the activation 322B. The steering engine 172 may repeat this process for multiple pairs of non-compliant-compliant prompts 174A, 174B to generate respective pairs of non-compliant-compliant activations 322A, 322B.

The steering engine 172 may divide the activations 322 into different sets 324 based on the activations' 322 respective content category labels 302. For example, as seen in FIG. 3B, a first set 324 may include activations 322 labeled with the “illegal activity” content label. A second set 324 (not shown) may include activations 322 labeled with the harassing content label, a third set 324 may include activations 322 labeled with the violent content label, and so on. For each set 324, the steering engine 172 may calculate the respective steering vector 158 associated with the respective content category of the set 324. For each set 324, the steering engine 172 may further divide the activations 322 of the respective set 324 into two subsets 326: a non-compliant subset 326A and a compliant subset 326B. The non-compliant subset 326A may include activations 322 with a non-compliant label 304. The compliant subset 326B may include activations 322 with a compliant label 304. For each set 324, the steering engine 172 may calculate a difference based on at least a comparison of the activations 322A in the non-compliant subset 326A and the activations 322B in the compliant subset 326B. For each set 324, the steering engine 172 may generate the steering vector 158 based at least on the difference, and the steering vector 158 may be associated with the content category for the set 324.

In one embodiment, the steering engine 172 may calculate the steering vector 158 for a content category according to the equation:

$$S = \frac{1}{n} {\sum }_{j = 1}^{n} [ {A}_{j}^{C} - {A}_{j}^{NC} ]$$

S is the steering vector 158. n is the number of activation 322 pairs in the set 324 of activations belonging to the content category. j is an index from 1 to n, Aⱼ^{C} is the compliant activation 322B of the activation pair identified by the index j. ANC is the non-compliant activation 322A of the activation pair identified by the index j.

In some embodiments, the steering engine 172 may remove a pair of activations 322A, 322B from the set 324 to which the activations 322A, 322B belong. The steering engine 172 may use noise filtering to determine which pair(s) of activations 322A, 322B to remove from the set 324. In one embodiment, the steering engine 172 may remove a pair of activations 322A, 322B where the difference between those activations 322A, 322B is below a threshold difference amount. The steering engine 172 may calculate the difference between the compliant activation 322B and the non-compliant activation 322A of each activation pair in a set 324, calculate the mean of the differences, and use the mean difference as the threshold difference amount. The steering engine 172 may then remove the activation pairs whose difference is less than the mean difference. By removing activation pairs whose differences are less than the mean difference (and, thus, may provide insignificant signal when calculating the steering vector 158), the steering engine 172 generates a steering vector 158 that is more effective at steering activations away from non-compliant content regions. In some embodiments, the steering engine may use principal component analysis (PCA), single value decomposition (SVD), or other noise filtering techniques to determine which pairs of activations 322A, 322B to remove from the set 324.

FIG. 3C illustrates another example data flow 350 of generating steering vectors for use in a policy compliance system that uses activation detection and steering of AI processing to comply with one or more applicable policies, according to at least one embodiment. Operations illustrated in FIG. 3C may be performed by the steering engine 172 of FIG. 1.

In one embodiment, the steering engine 172 may obtain a prompt 174. The prompt 174 may include a content category label 302. The prompt 174 may not include a compliance label 304. The steering engine 172 may provide the prompt 174 to the LM 132, which may process the prompt 174 and generate a response 352. During the processing, the activation sampling module 122 may sample an activation 322 outputted by one or more hidden neuron layers of the LM 132. The steering engine 172 may use the prompt 174 and the response 352 to generate an evaluation prompt 354. The evaluation prompt 354 may include a prompt with instructions for an LM to evaluate a prompt 174 and the prompt's 174 response 352 to evaluate whether the response 352 is safe or unsafe. For example, as shown in FIG. 3C, the evaluation prompt 354 may include the text:
You are a safety evaluator for chatbot outputs. For the given prompt, please evaluate whether the response is ‘safe’ or ‘unsafe’. If you are unsure, respond with ‘unsure’. Do not output anything other than the three options. Prompt:” <Prompt 174> “Chatbot Response:”<Response 352>

The steering engine 172 may provide the evaluation prompt 354 to the LM 308. As discussed above, the LM 308 may be an LM that is different from the LM 132 of the LM service 130 of FIG. 1. The LM 308 may be hosted on a server separate from the customer server 110, LM service 130, training server 160, or the steering server 170. In some embodiments, the LM 308 may include the LM 132. The LM 308 may process the evaluation prompt 354 and produce an output. The output of the LM 308 may be “safe,” “unsafe,” or “unsure.” The steering engine 172 may generate a label 304 based on the LM's 308 output. In one embodiment, the steering engine 172 may generate a non-compliant label 304 if the output is “unsafe” or a compliant label 304 if the output is “safe.” If the output of the LM 308 is “unsure,” the steering engine 172 may discard the prompt 174. The steering engine 172 may apply the label 304 to the activation 322.

The steering engine 172 may insert the activation 322 into a set 324 of activations. The activation set 324 may include the activation set 324 that corresponds to the content category label 302 of the activation 322. The activation 322 may be inserted into the subset 326 of the set 324 based on the compliance label 304 of the activation 322. The steering engine 172 may repeat the data flow 350 for multiple prompts 174. For each activation set 324, the steering engine 172 may calculate the steering vector 158 for the content category associated with that activation set 324 by calculating the mean of the non-compliant activations subset 326A, calculating the mean of the compliant activations subset 326B, and subtracting the non-compliant mean activation from the compliant mean activation. This can be represented by the following equation:

$$S = \frac{1}{\vert n \vert} \sum {A}^{C} - \frac{1}{\vert m \vert} \sum {A}^{NC}$$

S is the steering vector 158. n is the number of activations 322 in the subset 326B of compliant activations in the activation set 324. AC are the activations 322 in the subset 326B of compliant activations in the activation set 324. m is the number of activations 322 in the subset 326A of non-compliant activations in the activation set 324. ANC are the activations 322 in the subset 326A of non-compliant activations in the activation set 324.

The steering engine 172 may store the calculated steering vectors 158 in the datastore 150. The steering module 124 of the PCS 120 may retrieve one or more of the steering vectors 158 from the datastore 150 and use the steering vectors 158 during inference.

FIG. 4 illustrates an example data flow 400 of the deployment of a policy compliance system that uses activation detection and steering of AI processing to comply with one or more applicable policies, according to at least one embodiment. Operations illustrated in FIG. 4 may be performed by the PCS 120 of FIG. 1 and/or FIG. 2. The data flow 400 may be executed so the LM 132 complies with one or more relevant policies. An AI model 420 of the data flow 400 may form part of a language model (e.g., the LM 132 of FIG. 1 and FIG. 2), VLM, image/video content generation model, audio content generation model, public/private security model, industrial safety control model, robotic control model, autonomous vehicle control model, traffic control model, and/or any other applicable model. The data flow 400 may assist the AI model 420 with complying with one or more use policies, including but not limited to a hate content policy, a sexualized content policy, a harassing content policy, a profane content policy, a violent content policy, a self-harm content policy, a threat content policy, a minor-directed content policy, an illegal weapon content policy, a controlled substance content policy, a crime-facilitating content policy, a privacy content policy, a misinformation content policy, a fraud content policy, an intellectual property-infringing content policy (e.g., a copyright-infringing content policy, a trademark-infringing content policy, etc.), a plagiarism content policy, an economic harm content policy, a biological harm content policy, a malware content policy, a bias content policy, a jailbreak content policy, a product or services content policy, an off-topic content policy, a bias content policy; a contextual content policy, a hallucination content policy, and/or other policies or preferences.

Operations illustrated in FIG. 4 may include selecting an input 402. The input 402 may include an inference input, e.g., a live input received from a user interacting with the AI model 420. In some embodiments, the input 402 may include the prompt 202 to the LM 132 of FIG. 2. In some embodiments, the input 402 may include a user prompt augmented with any additional data, e.g., a system prompt, retrieval-augmented data, and/or the like. In some embodiments, the input 402 may be a single-turn prompt, e.g., a monologue prompt (or a solitary image) with a single question/inquiry produced by a user. In some embodiments, the input 402 may be a multi-turn prompt, e.g., a dialogue prompt that includes two or more user questions and at least one LM response (and/or a series of images).

In some embodiments, the AI model 420 may process the input 402 to generate an output 470. The output 470 may include the response 204 of FIG. 2. The AI model 420 may include any number of neuron layers 422A-N indicated schematically with vertical rectangles in FIG. 4. Neuron layers 422A-N whose outputs are provided as inputs into other neuron layers 422 (rather than producing the output 470) are referred to as hidden layers. As illustrated with an inset portion of FIG. 4, individual neuron layers 422A-N may include any number of nodes 424, an individual node 424 receiving any number of outputs of nodes of an upstream layer (or multiple upstream layers) and indicated via neural connections 426. In some embodiments, a neuron layer 422 may receive inputs generated by one or more downstream layers 422 (e.g., in the instances of recurrent neural networks). A set of nodal outputs produced by a given neuron layer 422 represents an activation, A, of that neuron layer 422 and may include as many components (integer or floating-point values) as there are nodes in the neuron layer 422.

In some embodiments, the activation sampling module 122 of the PCS 120 may sample one or more activations A₁, A₂, . . . , Aₙ generated by n target hidden neuron layers 422A-N and use these activations for policy monitoring of the model's outputs. For example, as seen in FIG. 4, the activation sampling module 122 may sample an activation A₁ from the neuron layer 422G. Although one sampled activation A₁ is shown in FIG. 4 for conciseness, any number n of target layers 422 may be sampled. In one example, an activation may be sampled from an attention layer of the LM 132, a hidden layer of a feed forward neural network, a residual stream layer, or an output layer. A sampled activation A₁ may have a large number of dimensions D (e.g., tens, hundreds or even more of values), such as may be determined by the total number of nodes in the target neuron layers 422. The activation sampling module 122 may provide the activation A₁ to a compliance space module 430. The compliance space module 430 may project the activation A₁ onto a compliance space. The compliance space may include a reduced-dimensionality latent space. The compliance space may include a smaller number of dimensions, d, than the number of dimensions in the activation A₁. In one example, various components of the activation A₁ may be aggregated, e.g., averaged, into a single component, and the activation A₁ may be converted into a vector with a reduced number of dimensions d. In some embodiments, the projection can use one or more non-linear operations.

The compliance space module 430 may determine whether the activation A₁ (either the original activation or the reduced-dimensionality activation) corresponds to a non-compliant content region in the compliance space. In one embodiment, the compliance space module 430 may use the activation A₁ as an input to a clustering algorithm, which may determine if the activation corresponds to a non-compliant content region.

FIG. 5 schematically illustrates example clustering in a two-dimensional compliance space 500 that may be used by a policy compliance system that performs steering of AI processing, according to at least one embodiment. Although a two-dimensional (d=2) compliance space 500 is illustrated in FIG. 5 for the case of viewing, the number of dimensions d of the compliance space 500 need not be limited and may be any number. Shown are three clusters of detection vectors—illustrated as points—in the compliance space 500. For example, a d-dimensional activation A₁ may be represented in the compliance space 500 as a vector connecting the origin of the compliance space 500 (associated with a null detection vector) with a point. FIG. 5 illustrates three clusters of detection vectors, Compliant (points illustrated with circles), Non-compliant (points illustrated with squares), and Non-Response (points illustrated with triangles), but any other number and types of clusters may be defined in specific applications, depending on a pertinent policy. Each cluster may correspond to a portion of a content region.

In some embodiments, clusters indicating a degree of non-compliance of an input/output (e.g., LM prompt/response) may be defined. Reference vectors f_{C}, f_{NC}, and f_{NR}—centroids, in this example—are illustrated with the black circle (centroid f_{C}, of Compliant cluster), the black square (centroid fN_{C}, of Non-compliant cluster), and the black triangle (centroid f_{NR} of Non-Response cluster). Belonging of a vector f to a specific cluster may be determined by computing distances Dⱼ=D(f,fⱼ) between the detection vector f and various cluster centroids fⱼ and then associating the detection vector f with the cluster having the minimum distance Dⱼ. In some embodiments of the PCS 120 deploying a Euclidean compliance space 500, a distance function D(.) may be a sum of squares of the differences between individual components of detection vector f and components of the respective centroids fⱼ. Boundaries between portions of the content region are shown with solid lines in FIG. 5 and correspond to the points of the compliance space 500 that are equidistant from at least two cluster centroids (with the intersection of all solid lines being equidistant from all three centroids). In higher-dimensional (d>2) compliance spaces, cluster boundaries may be d−2 dimensional hypersurfaces. In some embodiments, the distance function D(.) may weight differences between components along different axes of the compliance space 500 with different (e.g., empirically selected) weights. In some embodiments, a non-Euclidean compliance space may be used.

In one embodiment, the non-compliant content region (e.g., the region corresponding to the cluster represented by squares) of the compliance space 500 may may correspond to a non-compliant content category. The non-compliant content category may be a hate content category, a sexual content category, a harassing content category, a violent content category, a profane content category, a self-harm content category, a threat content category, a minor-directed content category, an illegal weapon content category, a controlled substance content category, a criminal content category, a privacy content category, a misinformation content category, a fraudulent content category, an intellectual property-infringing content category, a plagiarism content category, an economic harm content category, a biological harm content category, or a malware content category, a bias content category, a jailbreak content category, a product or services content category, an off-topic content category, a bias content category; a contextual content category, a hallucination content category, and/or other categories or preferences.

Returning to FIG. 4, during inference, in the instances where the compliance space module 430 determines that the activation A₁ is associated with a Non-compliant cluster (and, thus, corresponds to a Non-compliant content region), the PCS 120 may modify the activation A₁ to steer the AI model 420 towards the Compliant or Non-Response content region. In some embodiments, modifying the activation A₁ includes modifying the activation A₁ using a steering vector S₁. The steering vector S₁ may include a steering vector of the steering vectors 158 calculated by the steering engine 172 of FIG. 1 and stored in the datastore 150. In one embodiment, the steering module 124 may determine the content category associated with the activation A₁. For example, the compliance space module 430 may provide data to the steering module 124 indicating the content category associated with the activation A₁. The steering module 124 may retrieve the steering vector S₁ that corresponds to the content category and to the neuron layer 422G from which the activation A₁ was sampled. The steering module 124 may then modify the activation A₁ using the steering vector S₁ and cause the modified activation A₁+S₁ to be input into the subsequent neuron layer 422H of the AI model 420 (e.g., the neuron layer 422 immediately after the neuron layer 422G that produced the activation A₁). The AI model 420 may continue processing the input 402 to generate the output 470. The output 470 may include an output that is compliant with a content policy.

In one embodiment, modifying the activation A₁ using the steering vector S₁ may include combining the activation A₁ and the steering vector S₁. For example, the steering module 124 may add the steering vector S₁ to the activation A₁ using vector addition. In some embodiments, the steering module 124 may multiple the streeting vector S₁ by a scaling multiplier prior to combining the steering vector S₁ with the activation A₁.

FIG. 6 illustrates an example flow diagram for a method 600 directed to deployment of policy compliance systems, according to at least one embodiment. The method 600 may be used in the context of provisioning conversational AI including chatbot services, AI-based search engines, database-mining services, text-based services, voice-based services, image-based services, and/or the like. The method 600 may be used to facilitate detection of AI processing that is likely to result in outputs violating one or more pertinent policies and steering the AI processing towards outputs that comply with the policies. In at least one embodiment, the method 600 may be performed using one or more processing units of computing device 200 of FIG. 2, which may be (or include) a device associated with the customer server 110, the training server 160, the steering server 170 and/or other devices. In at least one embodiment, processing units performing the method 600 may execute instructions stored on a non-transient computer-readable storage media, e.g., memory 112 in FIG. 1. In at least one embodiment, the method 600 may be performed using multiple processing threads (e.g., CPU threads and/or GPU threads), with individual threads executing one or more individual functions, routines, subroutines, or operations of the method. In at least one embodiment, processing threads implementing any portions of the method 600 may be synchronized (e.g., using semaphores, critical sections, and/or other thread synchronization mechanisms). Alternatively, processing threads implementing any portions of the method 600 may be executed asynchronously with respect to each other. Various operations of the method 600 may be performed in a different order compared with the order shown. Some operations of the method 600 may be performed concurrently with other operations. In at least one embodiment, one or more operations shown in FIG. 6 may not always be performed.

At block 610, processing units executing the method 600 may process, using a neuron layer (e.g., the neuron layer 422G of AI model 420 in FIG. 4) of a model (e.g., the AI model 420), an input (e.g., the input to the neuron layer 422G from the previous neuron layer 422F) to generate an activation (e.g., the activation A₁). In some embodiments, the activation may be outputted by nodes (e.g., the nodes 424 in FIG. 4) of at least one neuron layer 422 of the one or more neuron layers 422 of the model 420.

At block 620, processing units may determine that the activation corresponds to a non-compliant content region in a reduced-dimensionality latent space. For example, the PCS 120 may use the activation sampling module 122 to sample the activation A₁ and may provide the activation A to the compliance space module 430. The compliance space module 430 may project the activation A; onto the reduced-dimensionality latent space and determine to which cluster of the latent space the activation belongs. The cluster may correspond to a content region, which may be a non-compliant content region.

At block 630, processing units may modify, using a steering vector (e.g., the steering vector S₁ of the steering vectors 158), the activation (e.g., the activation A₁). In one embodiment, the steering module 124 may retrieve, from the one or more steering vectors 158 stored in the datastore 150, the steering vector S₁ that corresponds to the non-compliant content region determined in block 620. The steering module 124 may modify the activation A₁ using the steering vector S₁ by combining the activation A₁ and the steering vector S₁ (e.g., adding the steering vector S₁ to the activation A₁).

At block 640, processing units may cause the modified activation (e.g., A₁+S₁) to be input into a second, subsequent neuron layer (e.g., the neuron layer 422H) of the model. The subsequent neuron layer may process the modified activation and generate another activation. The process may repeat for each layer of the model, and the model may produce an output.

At block 650, processing units may receive the output using the model and based on at least the modified activation. The output may include response 204 as seen in FIG. 2. At block 660, processing units may cause presentation of the output. For example, the response 204 may be displayed on the UI 104 of the user device 102.

In one embodiment, the method 600 may further include operations for calculating the steering vector used in block 630. At block 632, processing units may obtain a first set of activations generated by the neuron layer (e.g., the neuron layer 422G) and associated with a non-compliant state. In one embodiment, the first set of activations may include the non-compliant subset 326A of FIG. 3B or FIG. 3C generated from the LM 132 processing one or more prompts 174 of the steering server 170.

At block 634, processing units may obtain a second set of activations generated by the neuron layer and associated with a compliant state. In one embodiment, the second set of activations may include the compliant subset 326B of FIG. 3B. The second set of activations may be generated by processing, using the neuron layer 422G, one or more second inputs. The second inputs may be model prompts (e.g., prompts 174 of the steering server 170). Obtaining the one or more model prompts may include using a second model (e.g., the LM 308 of FIG. 3A) to modify one or more non-compliant prompts 174A and generate compliant prompts 174B, as shown in FIG. 3A. The compliant prompts 174B can be input into the LM 132 to generate the activations 322B, which are added to the second set of activations (e.g., the compliant subset 326B, as shown in FIG. 3B). In some embodiments, block 634 may further include using noise filtering techniques to remove pairs of activations 322 from the first set of activations (e.g., the non-compliant subset 326A) and from the second set of activations (e.g., the compliant subset 326B). For example, block 634 may include removing pairs of activations 322 whose difference is below a threshold difference amount, using PCA or SVD to remove pairs of activations 322, or using other noise filtering techniques, as discussed above.

In another embodiment, at blocks 632 and 634, processing units may use the model (e.g., the LM 132) to process one or more prompts 174 to generate model outputs. For example, as seen in FIG. 3C, the LM 132 may process one or more prompts 174 to generate one or more responses 352. Processing units may determine, using a second model (e.g., the LM 308 of FIG. 3C) and for each model output (e.g., response 352), whether the respective model output is associated with the non-compliant state or the compliant state. Responsive to the model output being associated with the non-compliant state, an activation associated with the model output (e.g., an activation 322 generated and sampled during the processing of the LM 132 to generate the model output) may be added to the non-compliant subset 326A of activations. Responsive to the model output being associated with the compliant state, the activation may be added to the compliant subset of activations 326B.

At block 636, processing units may calculate a difference based on a comparison of the first set of activations (e.g., the non-compliant subset 326A) and the second set of activations (e.g., the compliant subset 32B). For example, as discussed above, the steering engine 172 may calculate differences between activation pairs, or the steering engine may calculate a mean difference between the compliant subset of activations 326B and the non-compliant subset 326A. At block 638, processing units may generate the steering vector based on the difference. For example, the steering engine 172 may calculate the steering vector S according to one of the equations discussed above.

While the systems and methods described herein have discussed compliance and non-compliance with a safety policy and steering activations away from a non-compliant region that correlates with outputs that are non-compliant with a safety policy, the same techniques can be applied any content category where positive and negative samples are provided. The positive samples may act as compliant samples, and the negative samples may act as non-compliant samples. The systems and methods described herein can steer activations away from regions associated with the negative samples. For example, the systems and methods described herein can steer activations away from biased outputs, where the compliance space is divided into biased activations, non-biased activations, and neutral activations. Similarly, the systems and methods described herein can steer activations away from a certain topic, where the compliance space is divided into activations associated with the topic and activations not associated with the topic. In another example, the systems and methods can steer activations away from outputs that include hallucinations, where the compliance space is divided into activations associated with hallucinations and activations not associated with hallucinations.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, analytics operations, factory operations, generation and/or presentation of augmented reality (AR), virtual reality (VR), mixed reality (MR), etc., robotics operations, medical operations, security and surveillance (e.g., in a smart cities embodiment), autonomous or semi-autonomous machine applications, deep learning, environment simulation, object or actor simulation and/or digital twinning, data center processing, generative AI operations, conversational AI operations, operations involving vision language models, large language models, multi-modal language models, light transport simulations (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), and in-vehicle infotainment system for an autonomous or semi-autonomous machine, systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Inference and Training Logic

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a coprocessor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluccon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a UI 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA®) and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models- or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s) and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve-using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history- or at least a summary thereof- and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features-such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using-plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example embodiment in which the generative LM 1130 includes a transformer encoder-decoder suitable for use in implementing at least some embodiments of the present disclosure. For example, assume input text such as “Who discovered gravity” is tokenized (e.g., by the tokenizer 1110 of FIG. 11A) into tokens such as words, and each token is encoded (e.g., by the embedding component 1120 of FIG. 11A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture suitable for use in implementing at least some embodiments of the present disclosure. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Trec Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. Aₙ NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUS, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using a neuron layer of a model, an input to generate an activation of the neuron layer;
determining that the activation corresponds to a non-compliant content region in a reduced-dimensionality latent space;
modifying, using a steering vector, the activation;
causing the modified activation to be input into a second, subsequent neuron layer of the model;
receiving an output using the model and based at least on the modified activation; and
causing presentation of the output.

2. The method of claim 1, wherein the neuron layer of the model comprises at least one of:
an attention layer;
a hidden layer of a feed forward neural network;
a residual stream layer; or
an output layer.

3. The method of claim 1, wherein the non-compliant content region in the reduced-dimensionality latent space comprises a region corresponding to non-compliant content categories that are not compliant with one or more policies, the non-compliant content categories comprising at least one of:
a hate content category;
a sexual content category;
a harassing content category;
a violent content category;
a profane content category;
a self-harm content category;
a threat content category;
a minor-directed content category;
an illegal weapon content category;
a controlled substance content category;
a criminal content category;
a privacy content category;
a misinformation content category;
a fraudulent content category;
an intellectual property-infringing content category;
a plagiarism content category;
an economic harm content category;
a biological harm content category;
a malware content category;
a jailbreak content category;
a product or services content category;
an off-topic content category;
a bias content category;
a contextual content category; or
a hallucination content category.

4. The method of claim 1, further comprising:
obtaining a first set of activations generated by the neuron layer and associated with a non-compliant state;
obtaining a second set of activations generated by the neuron layer and associated with a compliant state; and
calculating a difference based at least on a comparison of the first set of activations and the second set of activations; and
generating the steering vector based at least on the difference.

5. The method of claim 4, wherein:
the second set of activations are generated by processing, using the neuron layer, a plurality of second inputs; and
the second inputs comprise a plurality of model prompts.

6. The method of claim 5, further comprising obtaining the plurality of model prompts, wherein the obtaining comprises modifying, using a second model, a second plurality of model prompts used to generate the first set of activations.

7. The method of claim 5, further comprising using noise filtering to remove, from the first set of activations and the second set of activations, a pair of activations.

8. The method of claim 4, further comprising:
processing, using the model, a plurality of model prompts to generate a plurality of model outputs; and
determining, using a second model and for each model output of the plurality of model outputs, whether the respective model output is associated with the non-compliant state or the compliant state.

9. The method of claim 8, further comprising, responsive to the respective model output being associated with the non-compliant state, adding an activation associated with the respective model output to the first set of activations.

10. The method of claim 8, further comprising, responsive to the respective model output being associated with the compliant state, adding the activation associated with the respective model output to the second set of activations.

11. A system comprising:
one or more processors to:
process, using a neuron layer of a model, an input to generate an activation of the neuron layer;
determine that the activation corresponds to a non-compliant content region in a reduced-dimensionality latent space;
modify, using a steering vector, the activation;
generate an output of the model based at least on the modified activation being processed using a second, subsequent neuron layer of the model; and
cause presentation of the output.

12. The system of claim 11, wherein the neuron layer of the model comprises at least one of:
an attention layer;
a hidden layer of a feed forward neural network;
a residual stream layer; or
an output layer.

13. The system of claim 11, wherein the non-compliant content region in the reduced-dimensionality latent space comprises a region corresponding to non-compliant content categories that are not compliant with one or more policies, the non-compliant content categories comprising at least one of:
a hate content category;
a sexual content category;
a harassing content category;
a violent content category;
a profane content category;
a self-harm content category;
a threat content category;
a minor-directed content category;
an illegal weapon content category;
a controlled substance content category;
a criminal content category;
a privacy content category;
a misinformation content category;
a fraudulent content category;
an intellectual property-infringing content category;
a plagiarism content category;
an economic harm content category;
a biological harm content category;
a malware content category;
a jailbreak content category;
a product or services content category;
an off-topic content category;
a bias content category;
a contextual content category; or
a hallucination content category.

14. The system of claim 11, wherein the one or more processors are further to:
obtain a first set of activations generated by the neuron layer and associated with a non-compliant state;
obtain a second set of activations generated by the neuron layer and associated with a compliant state; and
calculate a difference based at least on a comparison of the first set of activations and the second set of activations; and
generate the steering vector based at least on the difference.

15. The system of claim 14, wherein:
the second set of activations are generated by processing, using the neuron layer, a plurality of second inputs; and
the second inputs comprise a plurality of model prompts.

16. The system of claim 15, wherein the one or more processors are further to obtain the plurality of model prompts, wherein the obtaining comprises modifying, using a second model, a second plurality of model prompts used to generate the first set of activations.

17. The system of claim 15, wherein the one or more processors are further to use noise filtering to remove, from the first set of activations and the second set of activations, a pair of activations.

18. The system of claim 14, wherein the one or more processors are further to:
process, using the model, a plurality of model prompts to generate a plurality of model outputs; and
determine, using a second model and for each model output of the plurality of model outputs, whether the respective model output is associated with the non-compliant state or the compliant state.

19. The system of claim 11, wherein the system is comprised in at least one of:
an in-vehicle infotainment system for an autonomous or semi-autonomous machine;
a system for performing simulation operations;
a system for performing digital twin operations;
a system for performing light transport simulation;
a system for performing one or more medical operations;
a system for performing one or more factory operations;
a system for performing one or more analytics operations;
a system implementing one or more inference microservices;
a system for performing light transport simulations;
a system for performing collaborative content creation for 3D assets;
a system for performing deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more vision language models (VLMs);
a system implementing one or more multi-modal language models (MMLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

20. A processing device comprising processing circuitry to:
process, using one or more layers of a machine learning model, an input to generate one or more activations;
determine that at least one activation of the one or more activations corresponds to a non-compliant content region in a reduced-dimensionality latent space;
modify, using a steering vector, the at least one activation;
generate a response to the input based at least on one or more second layers of the machine learning model processing the at least one modified activation; and
at least one of:
send data corresponding to the response to one or more devices for presentation; or
cause presentation of the response.
